(19) United States
(12) Patent Application Publication
(10) Pub. No.: US 2023/0395003 A1
(43) Pub. Date: Dec. 7, 2023

(54) Fire Sign Device

(71) Applicant: Thea Klingberg, Las Vegas, NV (US)

(72) Inventor: Thea Klingberg, Las Vegas, NV (US)

(21) Appl. No.: 17/889,848

(22) Filed: Aug. 17, 2022

Related U.S. Application Data
(60) Provisional application No. 63/349,192, filed on Jun. 6, 2022.

(51) Int. Cl. G09F 19/00; G09F 13/00; G09F 7/18; G01K 1/024; G01K 3/00; G01K 11/12; C10L 11/04; C10L 11/06

(52) U.S. Cl. CPC G09F 19/00; G09F 13/00; G09F 7/18; G01K 1/024; G01K 3/005; G01K 11/12; C10L 11/04; C10L 11/06; G09F 2007/005

(57) ABSTRACT

The present invention relates generally to the field of campfires and fireplaces. More specifically, the present invention relates to a fire sign device primarily comprised of at least one stand and at least one sign. The stand can be placed within a campfire or a fireplace via an attachment mechanism that includes, but is not limited to: a clamp, a stake, a stand, etc., which may further be repositionable on the stand and adjustable. The sign further attaches to the stand and may be comprised of at least one indicia that is made from a heat-resistant thermochromic paint that becomes visible when heated. In a differing embodiment, the sign is shaped like the indicia itself. One embodiment of the device includes at least one LED within the indicia that illuminates when a temperature sensor of the device detects a temperature above a threshold value.

### CROSS-REFERENCE TO RELATED APPLICATION

The present application claims priority to, and the benefit of, U.S. Provisional Application No. 63/349,192 which was filed on Jun. 6, 2022, and is incorporated herein by reference in its entirety.

### FIELD OF THE INVENTION

The present invention relates generally to the field of campfires and fireplaces. More specifically, the present invention relates to a fire sign device primarily comprised of at least one stand and at least one sign. The stand can be placed within a campfire or a fireplace via an attachment mechanism that includes, but is not limited to: a clamp, a stake, a stand, etc., which may further be repositionable on the stand and adjustable. The sign further attaches to the stand and may be comprised of at least one indicia that is made from a heat-resistant thermochromic paint that becomes visible when heated. In a differing embodiment, the sign is shaped like the indicia itself. One embodiment of the device includes at least one LED within the indicia that illuminates when a temperature sensor of the device detects a temperature above a threshold value. Accordingly, the present disclosure makes specific reference thereto. Nonetheless, it is to be appreciated that aspects of the present invention are also equally applicable to other like applications, devices, and methods of manufacture.

### BACKGROUND

Fireplaces and campfires are enjoyable to sit near and around. As a result, fireplaces and campfires are often a focal point for conversation at social gatherings. However, individuals may desire a unique way to enhance the aesthetic experience of a fireplace or a campfire while hosting dinner parties, business events, and more.

Therefore, there exists a long-felt need in the art for a device that improves the aesthetic appearance of a fireplace or a campfire. There also exists a long-felt need in the art for a fire sign device that allows a user to display indicia that enhances the aesthetic experience of a fireplace or a campfire. Further, there exists a long-felt need in the art for a fire sign device that allows a user to display indicia that enhances the aesthetic experience of a fireplace or a campfire while using the fireplace or campfire itself.

The subject matter disclosed and claimed herein, in one embodiment thereof, comprises a fire sign device. The device is primarily comprised of at least one stand and at least one sign. The stand can be placed within a campfire or a fireplace via an attachment mechanism that includes, but is not limited to: a clamp, a stake, a stand, etc. Said attachment mechanisms may be repositionable on the stand and may be adjustable. The sign further attaches to the stand. In one embodiment, the sign is comprised of at least one indicia that is made from a heat-resistant thermochromic paint that becomes visible when heated. In a differing embodiment, the sign is shaped like the indicia itself. One embodiment of the device includes at least one LED within the indicia that illuminates when a temperature sensor of the device detects a temperature above a threshold value.

In this manner, the fire sign device of the present invention accomplishes all of the foregoing objectives and provides a device that improves the aesthetic appearance of a fireplace or a campfire. The device also allows a user to display an indicia of their choosing, and display the indicia to even further enhance the aesthetic experience of the fireplace or campfire.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fire sign device. The device is primarily comprised of at least one stand and at least one sign. In the preferred embodiment, the device is made from a durable metal material with a high melting point. The material is further preferably corrosion resistant to prevent against rust if left outdoors.

The stand allows the device to be placed and/or secured within a fire and is further comprised of at least one horizontal member. At least one attachment mechanism further fixedly or removably attaches to the horizontal member. The attachment mechanism may include at least one clamp, at least one stake, and/or at least one support stand.

The clamp can be secured around a natural or artificial fire log and may be any type of clamp known in the art. The stake may be a horizontal or vertical stake with at least one point that can be driven into a fire log to secure the stand to the log. The support stand is further comprised of at least one vertical member and at least one base. The base is preferably flat and allows the stand to rest within a fire in a free-standing manner. In one embodiment, the horizontal member resembles a log. The clamp, stake, and support stand may also resemble a log and/or wood.

The stand further receives at least one sign that may be fixedly or removably attached to the stand. In a removably attached embodiment, the horizontal member may further be comprised of at least one slot that allows the sign to slide into the horizontal member. In a further embodiment, the slot may have at least one fastener that retains the sign within the stand.

In various embodiments, the clamp, stake, and/or support stand may be repositionable along the horizontal member via at least one slot located on the underside of the horizontal member that receives the clamp, stake, and/or support stand. The clamp, stake, and/or support stand may further attach to the horizontal member via at least one hinge.

In one embodiment, the body of the sign may be rectangular or any other conventional shape. The body may have at least one indicia in the form of a phrase, a pattern, a logo, an emblem, an image, a symbol, a design, a letter, a word, a character, an animal, an advertisement, a brand, etc. The indicia may be made from a heat-resistant, thermochromic paint that becomes visible when the device is heated within a fire. The body and/or stand may further be comprised of at least one handle manufactured from a heat-resistant material to allow the stand and/or body to be removed from a fire while hot. The handle may further have at least one rubber grip for comfort.

In one embodiment, the sign is comprised of at least one temperature sensor in electrical communication with at least one LED that may be arranged in the form of the indicia. The at least one LED is further powered by at least one battery within the sign. Once the temperature sensor detects a temperature above a threshold value, the sensor communicates to at least one processor which then illuminates the LED. In this manner, the indicia can be better observed. The LED is preferably heat and fire resistant and may be any color known in the art. Alternatively or additionally, the LED may be illuminated and/or shut off using at least one button located on the body.

In one embodiment, the sign may be made from a wax material that can be set ablaze to start a fire (i.e., the sign is used as a fire-starting device). The sign may further be scented with at least one fragrance such as, but not limited to: fruit, pine, food, etc., to give off a pleasant aroma from the fire the device is within. In one embodiment the sign may be made of a wood material and can also be used to start and/or fuel the fire. In one embodiment, only the indicia may be made of said flammable materials mentioned above, and wherein the body is not made of said flammable material. In one embodiment, the indicia may be made from a combination of potassium perchlorate, titanium or aluminum, and dextrin to create a sparkler effect when lit ablaze.

Accordingly, the fire sign device of the present invention is particularly advantageous as it provides a device that improves the aesthetic appearance of a fireplace or a campfire by allowing a user to display indicia that enhances the aesthetic experience of a fireplace or a campfire. To do so, the device uses the fireplace or campfire itself. In this manner, the fire sign device provides a novel solution to a user wishing to make a fireplace or campfire more aesthetically pleasing.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a fire sign device of the present invention with a rectangular sign body in accordance with the disclosed architecture;

FIG. 2 illustrates a perspective view of one potential embodiment of a fire sign device of the present invention with an indicia shaped sign body in accordance with the disclosed architecture;

FIG. 3 illustrates a perspective view of one potential embodiment of a stand of one potential embodiment of a fire sign device of the present invention with a clamp in accordance with the disclosed architecture;

FIG. 4 illustrates a perspective view of one potential embodiment of a stand of one potential embodiment of a fire sign device of the present invention with a clamp while attached to a fire log in accordance with the disclosed architecture;

FIG. 5 illustrates a perspective view of one potential embodiment of a stand of one potential embodiment of a fire sign device of the present invention with a stake in accordance with the disclosed architecture; and

FIG. 6 illustrates a perspective view of one potential embodiment of a stand of a fire sign device of the present invention with a stand in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that improves the aesthetic appearance of a fireplace or a campfire. There also exists a long-felt need in the art for a fire sign device that allows a user to display indicia that enhances the aesthetic experience of a fireplace or a campfire. Further, there exists a long-felt need in the art for a fire sign device that allows a user to display indicia that enhances the aesthetic experiences of a fireplace or a campfire using the fireplace or campfire itself.

The present invention, in one exemplary embodiment, is comprised of a fire sign device. The subject matter disclosed and claimed herein, in one embodiment thereof, comprises a fire sign device. The device is primarily comprised of at least one stand and at least one sign. In the preferred embodiment, the device is made from a durable metal material with a high melting point. The material is further preferably corrosion resistant to prevent against rust if left outdoors.

The stand allows the device to be placed and/or secured within a fire and is further comprised of at least one horizontal member. At least one attachment mechanism further fixedly or removably attaches to the horizontal member and may include at least one clamp, at least one stake, and/or at least one support stand.

The clamp can be secured around a natural or artificial fire log and may be any type of clamp known in the art. The stake may be a horizontal or vertical stake with at least one point that can be driven into a fire log to secure the stand to the log. The support stand is further comprised of at least one vertical member and at least one base. The base is preferably flat and allows the stand to rest within a fire in a free-standing manner. In one embodiment, the horizontal member resembles a log. The clamp, stake, and support stand may also resemble a log and/or wood.

The stand further receives at least one sign that may be fixedly or removably attached to the stand. In a removably attached embodiment, the horizontal member may further be comprised of at least one slot that allows the sign to slide into the horizontal member. In a further embodiment, the slot may have at least one fastener that retains the sign within the stand.

In various embodiments, the clamp, stake, and/or support stand may be repositionable along the horizontal member via at least one slot that receives the clamp, stake, and/or support stand located on the underside of the horizontal member. The clamp, stake, and/or support stand may further attach to the horizontal member via at least one hinge.

In one embodiment, the body of the sign may be rectangular or any other conventional shape. The body may have at least one indicia in the form of a phrase, a pattern, a logo, an emblem, an image, a symbol, a design, a letter, a word, a character, an animal, an advertisement, a brand, etc. The indicia may be made from a heat-resistant, thermochromic paint that becomes visible when the device is heated within a fire.

The body and/or stand may further be comprised of at least one handle manufactured from a heat-resistant material to allow the stand and/or body to be removed from a fire while hot. The handle may further have at least one rubber grip for comfort.

In one embodiment, the sign is comprised of at least one temperature sensor in electrical communication with at least one LED that may be arranged in the form of the indicia. The at least one LED is further powered by at least one battery within the sign. Once the temperature sensor detects a temperature above a threshold value, the sensor communicates to at least one processor which then illuminates the LED. In this manner, the indicia can be better observed. The LED is preferably heat and fire resistant and may be any color known in the art. Alternatively or additionally, the LED may be illuminated and/or shut off using at least one button located on the body.

In one embodiment, the sign may be made from a wax material that can be set ablaze to start a fire (i.e., the sign is used as a fire-starting device). The sign may further be scented with at least one fragrance such as, but not limited to: fruit, pine, food, etc. to give off a pleasant aroma from the fire the device is within. In one embodiment the sign may be made of a wood material and also used to start and/or fuel the fire. In one embodiment, only the indicia may be made of said flammable materials mentioned above, and wherein the body is not made of said flammable material. In one embodiment, the indicia may be made from a combination of potassium perchlorate, titanium or aluminum, and dextrin to create a sparkler effect when lit ablaze.

Accordingly, the fire sign device of the present invention is particularly advantageous as it provides a device that improves the aesthetic appearance of a fireplace or a campfire by allowing a user to display indicia that enhances the aesthetic experiences of a fireplace or a campfire. To do so, the device uses the fireplace or campfire itself. In this manner, the fire sign device provides a novel solution to a user wishing to make a fireplace or campfire more aesthetically pleasing.

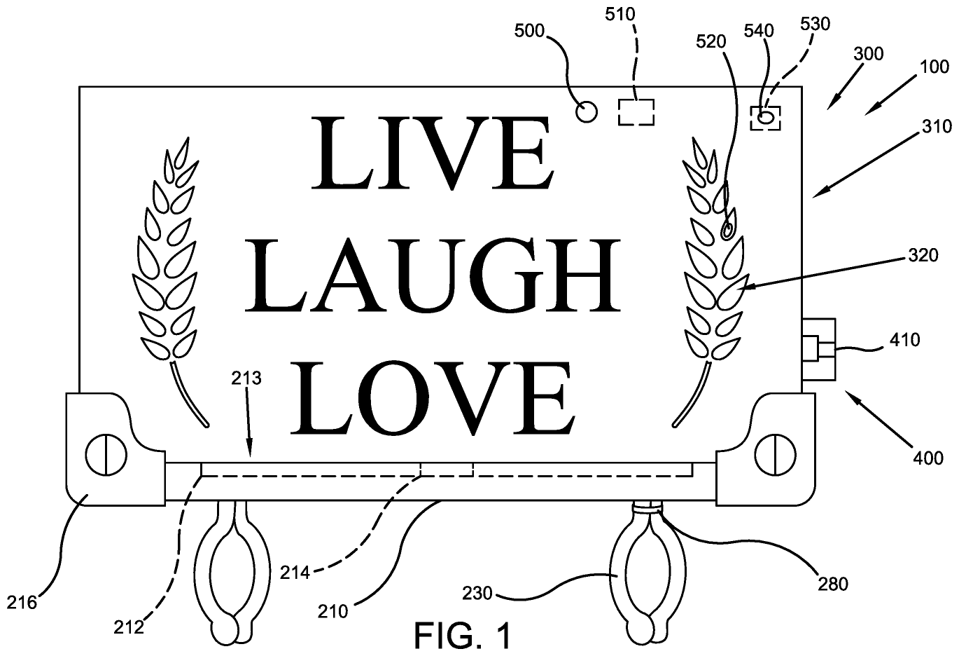

Referring initially to the drawings, FIG. 1 illustrates a perspective view of one potential embodiment of a fire sign device 100 of the present invention with a rectangular sign body in accordance with the disclosed architecture. The device 100 is primarily comprised of at least one stand 200 and at least one sign 300. In the preferred embodiment, the device 100 is made from a durable metal material such as stainless steel, cast iron, aluminum, etc. However, it should be appreciated that the metal material preferably has a melting point that exceeds 1650 degrees Fahrenheit (i.e., the average temperature of a campfire). The material is further preferably corrosion resistant to prevent against rust if left outdoors.

The stand 200 allows the device 100 to be placed and/or secured within a fire 10, wherein the fire 10 may include, but is not limited to: an outdoor/indoor wood fire or an outdoor/indoor artificial fire. The stand 200 is placed/secured within the fire 10 and is further comprised of at least one horizontal member 210. At least one attachment mechanism further fixedly or removably attaches to the horizontal member 210. Said mechanisms include, but are not limited to: at least one clamp 230, at least one stake 240, and/or at least one support stand 250.

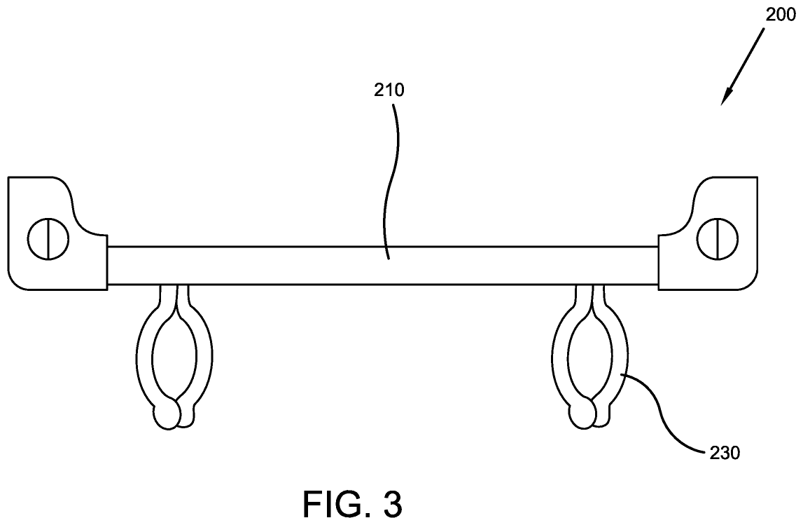

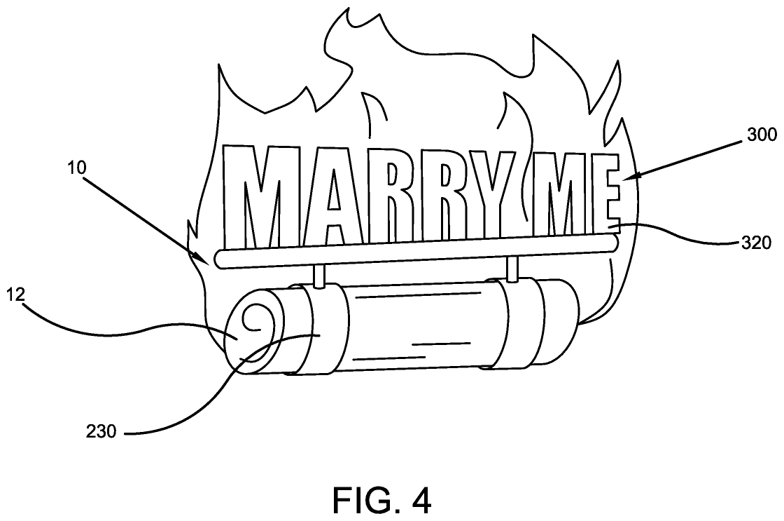

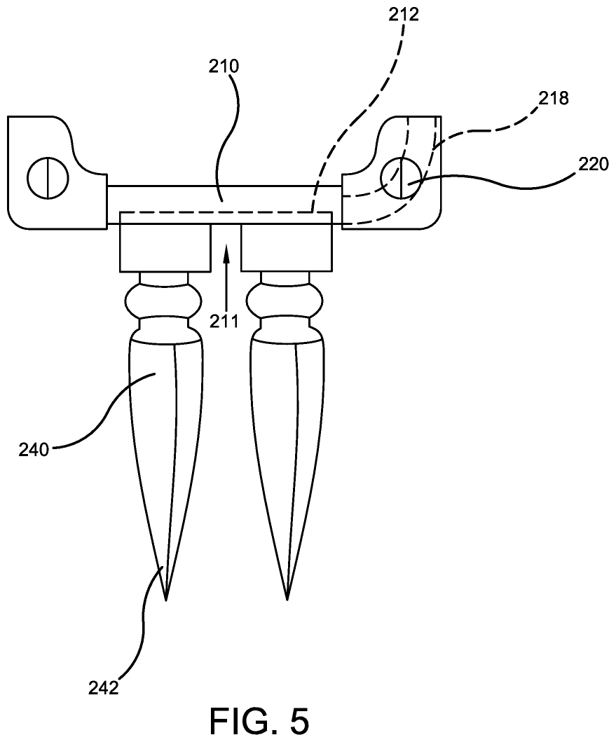

An embodiment of the stand 200 with at least one clamp 230 that can be secured around a natural or artificial fire log 12 is shown in FIGS. 3 and 4. The clamp 230 may be any type of clamp known in the art such as, but not limited to: a spring-loaded clamp, a locking clamp, a spiked clamp, etc. An embodiment of the stand 200 with at least one stake 240 includes a horizontal or vertical stake 240 with at least one point 242 that can be driven into a fire log 12 to secure the stand 200 to the log 12, as seen in FIG. 5.

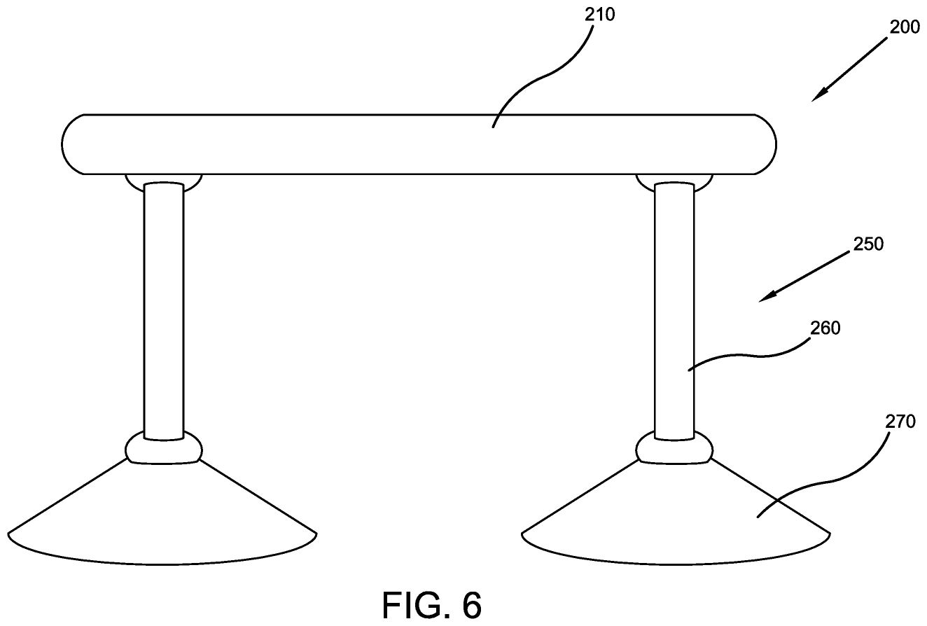

An embodiment of the stand 200 may also have at least one support stand 250 that is further comprised of at least one vertical member 260 and at least one base 270, as shown in FIG. 6. The vertical member 260 fixedly or removably attaches to the base 270, wherein the base 270 is preferably flat and allows the stand 200 to rest within a fire 10 in a free-standing manner. In one embodiment, the vertical member 260 is telescopic and therefore adjustable in length to allow the stand 200 to adjust in height to increase visibility. In differing embodiments, the stand 200 may have any combination of clamps 230, stakes 240, and stands 250. Alternatively, the stand 200 may only have the horizontal member 210. In one embodiment, the horizontal member 210 resembles a log. The clamp 230, stake 240, and support stand 250 may also resemble a log and/or wood.

The stand 200 further receives at least one sign 300. In one embodiment, the sign 300 is fixedly attached to the horizontal member 210 of the stand 200. In another embodiment, the sign 300 is removably attached to the stand 200. In a removably attached embodiment, the horizontal member 210 may further be comprised of at least one slot 212 that allows the sign 300 to slide into the horizontal member 210. In a further embodiment, the slot 212 may have at least one fastener 214, such as, but not limited to, a magnet, that retains the sign 300 within the stand 200. In another embodiment, the horizontal member 210 is also comprised of at least one corner member 216. The corner member 216 may further have at least one slot 218 that allows the sign 300 to slide into the corner member 216 to further secure the sign 300 to the stand 200. In a further embodiment, the slot 212 may have at least one fastener 220, such as, but not limited to, a magnet, that retains the sign 300 within the corner member 216.

In various embodiments, the clamp 230, stake 240, and/or support stand 250 may be repositionable along the horizontal member 210 via at least one slot 212 that receives the clamp 230, stake 240, and/or support stand 250 located on the underside 211 of the horizontal member 210 (i.e., opposite the slot 212 on the top side 213 of the horizontal member 210). The clamp 230, stake 240, and/or support stand 250 may further attach to the horizontal member 210 via at least one hinge 280. The hinge 280 may be any type of hinge known in the art such as, but not limited to: an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc.

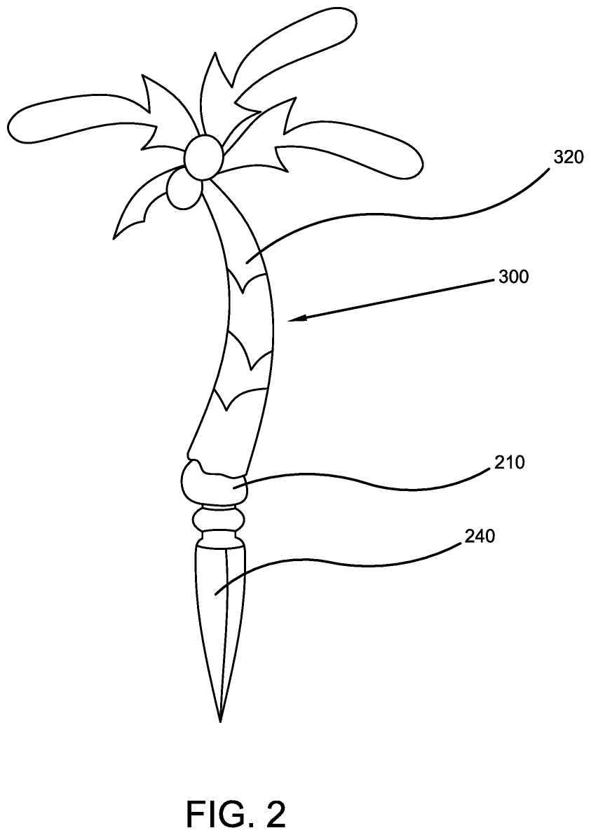

In one embodiment, the body 310 of the sign 300 may be rectangular or any other conventional shape such as, but not limited to, square, triangular, polygonal, circular, etc. The body 310 may have at least one indicia 320 in the form of a phrase, a pattern, a logo, an emblem, an image, a symbol, a design, a letter, a word, a character, an animal, an advertisement, a brand, etc. The indicia 320 may be made from a heat-resistant, thermochromic paint that becomes visible when the device 100 is heated within a fire 10. In a differing embodiment, the indicia 320 is made from visible paint. In a differing embodiment, the body 310 of the sign 300 is shaped like the indicia 320 itself, as seen in FIG. 2.

The body 300 and/or stand 200 may further be comprised of at least one handle 400. The handle is preferably manufactured from a heat-resistant material to allow the stand 200 and/or body 300 to be removed from a fire 10 while hot. The handle 400 may further have at least one rubber grip 410 for comfort made from a rubber material such as, but not limited to: neoprene, silicone, nitrile, EPDM, Styrene-Butadiene, Butyl, natural, fluorosilicate, etc.

In one embodiment, the sign 300 is comprised of at least one temperature sensor 500. The temperature sensor 500 is further in electrical communication with at least one LED 520 that may be arranged in the form of the indicia 320. The at least one LED 520 is further powered by at least one battery 510 within the sign 300. The battery 510 may be a disposable battery 510 or a rechargeable battery 510 in the form of an alkaline, nickel-cadmium, nickel-metal hydride battery 510, etc., such as any 3V-12 volts DC battery 510 or other conventional battery 510 such as A, AA, AAA, etc., that supplies power to the device 100. Throughout this specification the terms “battery” and “batteries” may be used interchangeably to refer to one or more wet or dry cells or batteries 510 of cells in which chemical energy is converted into electricity and used as a source of DC power. References to recharging or replacing batteries 510 may refer to recharging or replacing individual cells, individual batteries 510 of cells, or a package of multiple battery cells as is appropriate for any given battery 510 technology that may be used.

Once the temperature sensor 500 detects a temperature above a threshold value, such as, but not limited to, 100 degrees Fahrenheit, the sensor 500 communicates to at least one processor 530 which then illuminates the LED 520. In this manner, the indicia 320 can be better observed. The LED 520 is preferably heat and fire resistant and may be any color known in the art. Alternatively or additionally, the LED 520 may be illuminated and/or shut off using at least one button 540 located on the body 310.

In one embodiment, the sign 300 may be made from a wax material that can be set ablaze to start a fire (i.e., wherein the sign 300 is used as a fire-starting device). In said embodiment, the sign 300 may further be scented with at least one fragrance. Said fragrance can include, but is not limited to: fruit, pine, food, etc., to give off a pleasant aroma from the fire 10. In one embodiment, the sign 300 may be made of a wood material and also used to start and/or fuel the fire. In one embodiment, only the indicia 320 may be made of said flammable materials mentioned above, and wherein the body 310 is not made of said flammable material. In one embodiment, the indicia 320 may be made from a combination of potassium perchlorate, titanium or aluminum, and dextrin to create a sparkler effect when lit ablaze.

It should be appreciated that the device 100 is not necessarily limited in use to any particular type of fire or fire source or placement location, and may be used, without limitation, inside or on a wall of a fireplace (gas, electric, propane or wood), hanging over a campfire, and open or enclosed structure capable of emitting flames or the appearance thereof, etc. Device 100 can also be used in an open pit or fire grill or any other open fire containing device including, without limitation, fire and ice fires, backyard flat open places that emit flames from stones, etc.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “fire sign device” and “device” are interchangeable and refer to the fire sign device 100 of the present invention.

Notwithstanding the foregoing, the fire sign device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the fire sign device 100 as shown in the FIGS. are for illustrative purposes only, and that many other sizes and shapes of the fire sign device 100 are well within the scope of the present disclosure. Although the dimensions of the fire sign device 100 are important design parameters for user convenience, the fire sign device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fire sign device comprising:
a stand comprised of a horizontal member;
a sign; and
an indicia positioned on the sign.

2. The fire sign device of claim 1, wherein the indicia is comprised of a thermochromic paint.

3. The fire sign device of claim 2, wherein the thermochromic paint is heat resistant.

4. The fire sign device of claim 1, wherein the sign is fixedly attached to the stand.

5. A fire sign device comprising:
a stand comprised of a horizontal member having a slot and a stand fastener;
a sign;
an indicia; and
a fastener.

6. The fire sign device of claim 5, wherein each of the stand and the sign are comprised of a metal material with a melting point that exceeds 1,650 degrees Fahrenheit.

7. The fire sign device of claim 6, wherein the metal material is corrosion resistant.

8. The fire sign device of claim 5, wherein the stand is further comprised of a clamp, a stake, or a support stand.

9. The fire sign device of claim 8, wherein the clamp, the stake, or the support stand is repositionable along the horizontal member via a secondary slot on the horizontal member.

10. The fire sign device of claim 8, wherein the clamp, the stake, or the support stand attaches to the horizontal member via a hinge.

11. The fire sign device of claim 8, wherein the support stand is adjustable and telescopic.

12. The fire sign device of claim 8, wherein the clamp is a spring-loaded clamp, a locking clamp, or a spiked clamp.

13. A fire sign device comprising:
a stand comprised of a horizontal member having a slot and a first fastener, and a corner member having a second fastener; and
a sign in a shape of an indicia and comprised of a third fastener.

14. The fire sign device of claim 13, wherein each of the first fastener, the second fastener and the third fastener is a magnet fastener.

15. The fire sign device of claim 13, wherein the corner member is further comprised of a slot.

16. The fire sign device of claim 13, wherein the indicia is a phrase, a pattern, a logo, an emblem, an image, a symbol, a design, a letter, a word, a character, an animal, an advertisement or a brand.

17. The fire sign device of claim 13, wherein the sign is further comprised of a handle comprised of a heat-resistant material.

18. The fire sign device of claim 13, wherein the sign or the indicia is comprised of a wax material.

19. The fire sign device of claim 18, wherein the wax material is scented.

20. The fire sign device of claim 13, wherein the indicia of the sign is further comprised of an LED powered by a battery that is activated by a temperature sensor when the temperature sensor detects a temperature over 100 degrees Fahrenheit.
